(19) United States
(12) Patent Application Publication
(10) Pub. No.: US 2003/0220846 A1
(43) Pub. Date: Nov. 27, 2003

(54) How to order selected goods without list

(76) Inventor: Petr Hejl, White Rock (CA)

Correspondence Address: Clifford W. Vermette, Vermette & Co., Box 40, Granville Square, 200 Granville Street, Suite 230, Vancouver, BC, V6C 1S4, CA

(21) Appl. No.: 10/445,228

(22) Filed: May 27, 2003

(30) Foreign Application Priority Data
May 24, 2002 (CA) 2.387.457

(51) Int. Cl. G06F 17/60

(52) U.S. Cl. 705/26

(57) ABSTRACT

According to the invention there is provided a method of facilitating the ordering of goods and/or services using a communication device.

### FIELD

The present invention relates to a method of ordering various kinds of goods and services, when the list of goods or services (offer) is not available to the customers.

### BACKGROUND

When ordering goods and services using mobile phones, delivering the list of goods and services to the customer is problematic. Examples of the kind of goods that could be ordered and delivered in this way are logos, pictures or ringtones on mobile phones. With printed matters it is difficult and inconvenient to deliver them to the customers (SMS messages work online). With questions (help) concerning the list of goods via SMS messages on mobile phones, the amount of text for the answers is very limited (one SMS message may usually contain 160 characters and it is difficult for the customer to read and understand many SMS messages at one time)

The number of logos, pictures or ringtones, etc. offered should be huge in order to cover most of requests of goods and services coming from the customers. There should be thousands of categories and object names available, such as animals, sport, etc

### SUMMARY OF THE INVENTION

According to the invention there is provided a method of facilitating the ordering of goods and/or services using a communication device which includes establishing a database of goods and services by selecting first a subset of the most popular goods and services, then selecting a sufficient number of additional goods and services to provide a viable database. Next a list of generic names of goods and services and names of their corresponding species is established. For each word of the database, a table of a primary word and of associated secondary words is constructedor. An inspection of each word is conducted in response to a user initiated search and key words of the user initiated search request are set so that singular equals plural, and small letters equal capital letters. For each key word the table of primary or secondary words is searched to locate the same or an equivalent word and replacing that located word by the equivalent primary word. The equivalent primary word is used to locate the name of the generic good or service. Next searching a list of species corresponding to the generic name of the good or service for the good or service previously ordered is conducted and a different species is selected corresponding to that generic name.

### DESCRIPTION OF THE PREFERRED EMBODIMENT

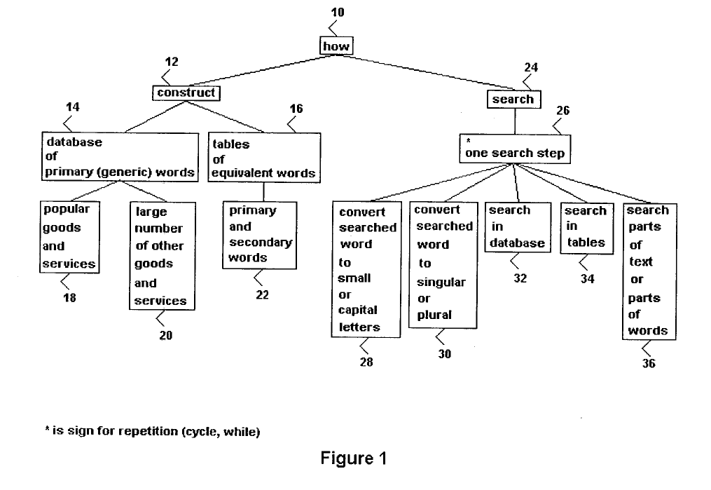

Referring to FIG. 1, the method of facilitating the ordering of goods and/or services using a communication device includes constructing a database of goods and services at step 12 by selecting first a subset of the most popular goods and services at step 18, then selecting a sufficient number of additional goods and services at step 20 to provide a viable database. Next a list of generic names of goods and services and names of their corresponding species is established at step 14. For each word of the database, a table of a primary word and of associated secondary words is constructed at steps 16 and 22.

An inspection of each word is conducted in response to a user initiated search at steps 24 and 26 and key words of the user initiated search request are set so that small letters equal capital letters at step 28 and singular equals plural at step 30. For each key word the table of primary or secondary words is searched at steps 32, 34 and 36 to locate the same or an equivalent word and replacing that located word by the equivalent primary word. The equivalent primary word is used to locate the name of the generic good or service. Next searching a list of species corresponding to the generic name of the good or service for the good or service previously ordered is conducted and a different species is selected corresponding to that generic name.

Most Favorite and Frequent

The production of logos, pictures or ringtones must concentrate first on the best known (most favorite, frequently used) names. These are, for example, general names (animals, things), music stars, sport teams (in soccer, hockey, basketball, baseball).

Small and Capital Letters Insensitive

The search of names is small and capital letter insensitive, e.g. “Cat” or “CAT” is the same as “cat”.

Singular-Plural Insensitive

The search of names is singular-plural insensitive, i.e. the same name in singular as well as plural is found. E.g. “cat” as well as “cats” are found in the system. In english, basically the ending -s, -y, -us, -ies, -ia are removed from or added to the searched name. Special instances should be treated as well (“person”-“people”, “child”-“children”. . . ).

5. Equivalent Words

There are files of equivalent words, which are mapped into the available names, which designate (identify) the logos, pictures or ringtones existing in the system. And the available names are then searched, e.g. the names “kitty”, “mouser” or “killick” are to be mapped to the name “cat” and the name “cat” is to be searched.

Word Parts

The searched word can also be a part of the available (existing) names. Or the available (existing) name can be a part of the searched word. In both cases, the name is found.

Memory

The system remembers the names of logos, pictures or ringtones, which were already sent to the specified customer. When the same name is requested from the same customer again, another mottif with this name may be delivered to this customer. In the system there are tens of pictures of “cat”, which are delivered to the customer one after another (if requested). The customer must also have the choice to order the same picture two or many times, e.g. using its serial number or its serial number within given category or within given name (e.g. cat004).

Remark.

Single points, stated above, or their combination is used. For example the word to be found is converted into small letters and singular, then mapped into available names and logos, pictures or ringtones having this name are then searched in the lists of logos, pictures or ringtones.

New and Advantages

By this method, it is possible for customers to order some goods using mobile phones, e.g. logos, pictures or ringtones, without having the lists of goods available.

I claim:

1. A method of facilitating the ordering of goods and/or services using a communication device, comprising:
(a) establishing a database of goods and services by selecting first a subset of the most popular goods and services, then selecting a sufficient number of additional goods and services to provide a viable database;
(b) establishing a list of generic names of goods and services and names of their corresponding species;
(c) for each word of the database, constructing a table of a primary word and of secondary words for each primary word;
(d) inspecting each word of a user initiated search and setting key words of the user initiated search request so that singular equals plural, and small letters equal capital letters; and for each key word searching the table of primary or secondary words to locate the same or an equivalent word and replacing that located word by the equivalent primary word;
using the equivalent primary word to locate the name of the generic good or service;
(e) searching a list of species corresponding to the generic name of the good or service for the good or service previously ordered and selecting a different species corresponding to that generic name.
